(19) United States
(12) Patent Application Publication
(10) Pub. No.: US 2023/0396031 A1
(43) Pub. Date: Dec. 7, 2023

(54) LASER DRIVER MODULE THAT PRODUCES A BEAM OF POLYCHROMATIC DRIVER PULSES USING FEWER PUMP LASERS

(71) Applicant: University of Rochester, Rochester, NY (US)

(72) Inventors: Jonathan D. Zuegel, Rochester, NY (US); Christophe Dorrer, Rochester, NY (US)

(73) Assignee: University of Rochester, Rochester, NY (US)

(21) Appl. No.: 18/323,976

(22) Filed: May 25, 2023

Related U.S. Application Data
(60) Provisional application No. 63/365,714, filed on Jun. 2, 2022.

(51) Int. Cl. H01S 3/091; H01S 3/00; H01S 3/10

(52) U.S. Cl. CPC H01S 3/0912; H01S 3/0057; H01S 3/1001

(57) ABSTRACT

At least one beam of pump pulses is combined in a nonlinear process with a plurality of monochromatic beams, each containing signal pulses of a unique wavelength. This produces an ensemble of beams of pulses having wavelengths of medium length. Then, all of the pulses in all of the beams in the ensemble are subject to second harmonic generation, optical parametric amplification, sum-frequency generation, or combinations to reduce the wavelengths of those pulses to ultraviolet wavelengths, thereby creating driver pulses. Driver beams made up of those reduced-wavelength driver pulses can then be focused upon a fuel pellet.

### GOVERNMENT RIGHTS

This invention was made with government support under award number DE-NA0003856 awarded by the Department of Energy National Nuclear Security Administration, and under award number DE-SC0021032 awarded by the Department of Energy Office of Science. The government has certain rights in the invention.

### BACKGROUND OF THE INVENTION

The invention relates to inertial fusion energy (IFE), and more particularly relates to energy produced by laser-driven inertial confinement fusion. In its most immediate sense, the invention relates to a laser driver module for use in generation of fusion energy.

Inertial confinement fusion (ICF) is now being investigated as a technology for generating power. In ICF, a tiny fuel pellet is highly compressed so as to drastically increase its temperature and pressure. The pellet implodes, but in the few nanoseconds before it does so it produces energy by nuclear fusion. (Efforts are presently underway to determine whether it is commercially feasible to capture this energy and to use it to supply electrical power.)

Compression of the pellet is accomplished by focusing intense laser energy upon the pellet. The apparatus that generates the beam is called a driver, the driver makes driver pulses incident upon the fuel pellet, and the present invention is a module that, together with others of like kind, produces driver pulses having appropriate characteristics.

Driver pulses induce implosion of the fuel pellet more efficiently when they are polychromatic, i.e. when they are made up of laser pulses having many different wavelengths. In a conventional laser driver, N lasers are needed to produce a polychromatic driver pulse made up of N pulses each of different wavelength. High-energy lasers are expensive, and existing laser drivers (such as the StarDriver) can have as many as 10⁴ or 10⁵ of them. It would be advantageous to provide a module for use in a laser driver that produced polychromatic driver pulses using fewer lasers.

In accordance with the invention, at least one beam of pump pulses is combined in a nonlinear process with a plurality of monochromatic beams each containing low-energy signal pulses of different wavelengths. This produces a beam with an ensemble of high-energy pulses of different wavelengths. Then, all of the pulses in the ensemble are subject to second harmonic generation, sum-frequency generation, or both to reduce the wavelengths of the pulses in those beams to ultraviolet wavelengths, thereby creating driver pulses. Driver beams made up of those reduced-wavelength driver pulses can then be focused upon a fuel pellet.

In a first preferred embodiment, the nonlinear process is optical parametric amplification. In this process, the signal pulses are amplified, the pump pulses are depleted, and idler pulses are generated. In subsequent processing steps, both the amplified signal pulses and the idler pulses are converted into ultraviolet driver pulses of differing wavelengths.

In a second preferred embodiment, the nonlinear process is itself second harmonic generation or sum-frequency generation.

The first preferred embodiment is a module and can be replicated as necessary to produce driver beams of driver pulses having the desired polychromatic characteristics.

The second preferred embodiment uses a single signal source that produces a polychromatic primary beam of signal pulses and a plurality of pump sources, each of which includes a pump laser. The signal pulses and pump pulses are introduced into a matrix of sum-frequency generators. The matrix produces a plurality of driver beams containing driver pulses.

In both preferred embodiments, the signal pulses and the pump pulses have wavelengths between infrared and ultraviolet and the driver pulses have ultraviolet wavelengths.

### BRIEF DESCRIPTION OF THE DRAWINGS

The invention will be better understood with reference to the following illustrative and non-limiting drawings, in which:

FIG. 1 is a schematic diagram of a first preferred embodiment of the invention; and

FIG. 2 is a schematic diagram of a second preferred embodiment of the invention.

### DETAILED DESCRIPTION OF PREFERRED EMBODIMENTS

The Figures discussed below are schematic and distances are not shown to scale. Analogous references bear analogous references. Furthermore, it will be understood that the laser pulses herein discussed must be precisely shaped to deliver energy with sufficient efficiency. The details of such shaping are not discussed.

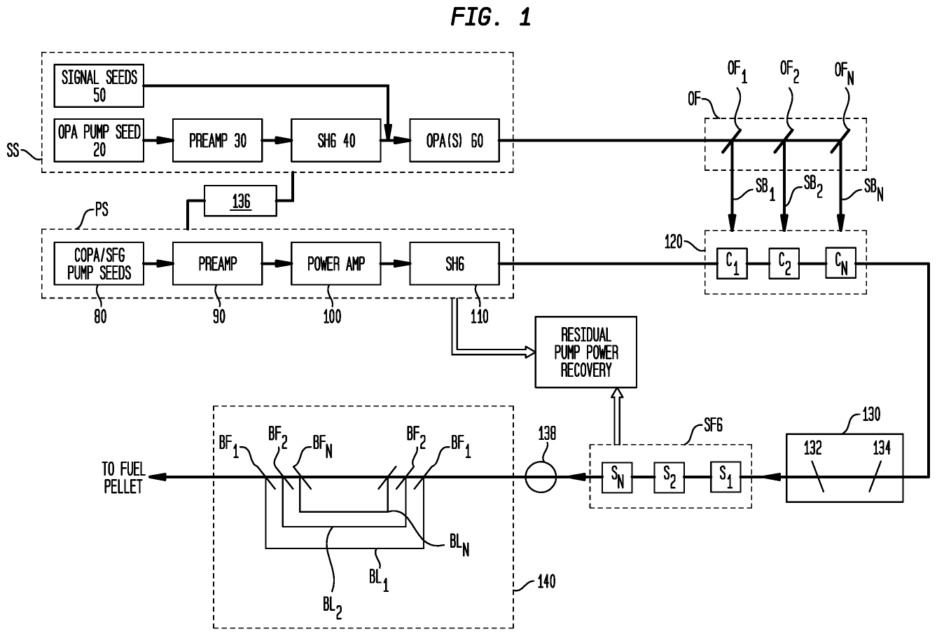

### First Preferred Embodiment—FIG. 1

A signal source generally indicated by reference SS contains a fiber laser 20 that provides a beam of pump seed signals for laser pump pulses. The pulses in this pump seed signal beam are amplified in a laser preamplifier 30, which feeds a second harmonic generator 40. The output of the second harmonic generator 40 is combined with a beam of laser signal seed pulses that is produced by a signal seed fiber laser 50. The superposition of these laser beams is input to one or more optical parametric amplifiers (OPAs) 60. (If there is more than one OPAs, the OPAs are connected in series.)

The OPA(s) 60 produce a polychromatic primary beam of infrared signal pulses. Producing a polychromatic primary beam of infrared signal pulses is the function of the signal source SS. It will be understood that the signal source SS may be differently configured as long as it produces a polychromatic primary beam of infrared signal pulses. The configuration of the signal source SS is not part of the invention.

A COPA/SFG pump source PS contains an ytterbium-based fiber laser 80 that produces a beam of pump seed signals. (Other lasers can also be used.) At present, if the first preferred embodiment of the invention is intended to be used for ICF, all of the laser amplifiers 30, 90 and 100 can advantageously be neodymium-doped glass tuned to deliver single-shot pulses having a wavelength of 1053 nm. Alternatively, if the first preferred embodiment is intended to be used for inertial fusion energy (IFE), all of the lasers 30, 90 and 100 can advantageously be neodymium- or ytterbium-doped yttrium lithium fluoride tuned to deliver multi-Hz pulses having a wavelength of 1047 nm or 1018 nm, respectively. (Other constructions for lasers 30, 90 and 100 are possible.) This beam is input to a laser preamplifier 90, which feeds a laser power amplifier 100. The beam output from the power amplifier 100 is input to a second harmonic generator 110.

The second harmonic generator 110 outputs a monochromatic beam containing monochromatic pump pulses having wavelengths between infrared and ultraviolet (“medium wavelengths”). Producing this beam is the function of the pump source PS. It will be understood that the pump source PS may be differently configured as long as it produces a beam of pump pulses having medium wavelengths. The configuration of the pump source PS is not part of the invention. The beam of pump pulses produced by the pump source PS is time-multiplexed and is also coordinated with the primary beam of signal pulses. These matters are discussed below.

The polychromatic primary beam from the signal source SS (i.e. the polychromatic beam from the output of the OPA(s) 60) is directed through an optical filter OF. In this example, the optical filter OF is made up of a plurality of filters OF₁, OF₂, . . . OF_{N1}. In some embodiments, the filters are series-connected dichroic filters, and the number of filters OF₁, OF₂ . . . OF_{N1} is chosen to equal one-half the number of different wavelength driver pulses that will eventually make up a polychromatic driver pulse that is delivered to a fuel pellet (not shown). In other words, if the laser driver is set up to simultaneously deliver driver pulses of six different wavelengths to the fuel pellet, there will be three dichroic filters OF₁-OF₃. Each of the dichroic filters is tuned to deflect a secondary beam SB₁, SB₂, . . . SB_{N1} of signal pulses having a particular selected wavelength while allowing all the other components of the primary beam to pass through to the next dichroic filter SB₁, SB₂, . . . SB_{N1}. Each of these secondary beams will be monochromatic, containing signal pulses having a single unique wavelength, i.e. having a wavelength that is different from the wavelengths in all of the other secondary beams. Although in this example the optical filter OF contains the same number of filters OF₁, OF₂, . . . OF_{N1} as secondary beams SB₁, SB₂, . . . SB_{N1}, this is not necessary. Indeed, it is possible to use a single filter as the only filter in the optical filter OF.

The beam of pump pulses from the pump source PS and all the secondary beams of signal pulses are all input to a collinear optical parametric amplifier (COPA) 120. The COPA 120 has N stages C₁, C₂ . . . C_{N1}, with N1 equaling the number of secondary beams from the signal source SS. Each stage C₁, C₂ . . . C_{N1} is a crystal of e.g. lithium triborate, potassium dihydrogen phosphate (KDP), or deuterated potassium dihydrogen phosphate (DKDP). (Other materials are possible.) When a pump pulse from the pulse source PS interacts with a signal pulse in one of the stages C₁, C₂ . . . C_{N1}, a nonlinear interaction occurs and three pulses result. One is an amplified signal pulse, another is a depleted pump pulse, and the third is an idler pulse having a frequency that is the difference of the frequencies of the signal pulse and the pump pulse. The amplified signal pulse and the idler pulse are paired. Both have medium wavelengths.

As stated above, one component of each such interaction is a signal pulse having a unique frequency, i.e. a frequency that is different from the frequencies of all the other signal pulses. It therefore follows that each of the N stages C₁, C₂ . . . C_{N1} in the COPA 120 produces two beams containing paired pulses—a beam made up of amplified signal pulses and a beam made up of idler pulses—of unique wavelengths. Hence, the COPA 120 doubles the number of beams of unique frequency from the polychromatic beam produced by the signal source SS.

The polychromatic pulse beam produced by the COPA 120 is then directed to a retiming stage 130. As will become clear below, the retiming stage 130 makes it possible to synchronize groups of pump pulses with groups of signal pulses and idler pulses in a subsequent multistage sum-frequency generator SFG. The structure and operation of the sum-frequency generator SFG will be described first in general terms.

The sum-frequency generator SFG contains a plurality of series-connected stages S₁, S₂, . . . S_{N1}. (The number of stages in the sum-frequency generator SFG may be different than the number of stages in the COPA 120.) Each of the stages S₁, S₂, . . . S_{N1} is a crystal of e.g. lithium triborate, potassium dihydrogen phosphate, or deuterated potassium dihydrogen phosphate. (Other materials are possible.) Each beam pair, i.e. pairs of amplified signal pulses and idler pulses, interacts with pump pulses in one of the stages S₁, S₂, . . . S_{N1}. In this nonlinear interaction, the amplified signal pulses and idler pulses are converted to two new ultraviolet driver pulses. One of these driver pulses has a frequency equal to the sum of the frequencies of the original amplified signal pulse and the pump pulse, and other driver pulse has a frequency equal to the sum of the frequencies of the idler pulse and the pump pulse. Thus, in this first preferred embodiment, the infrared signal and pump pulses generated by the lasers 20 and 80 are used to create ultraviolet driver pulses. Ultraviolet pulses are better suited for use as driver pulses; they deliver more useful energy to the fuel pellet than infrared pulses.

As stated above, a retiming stage 130 is located between the COPA 120 and the sum-frequency generator SFG. This is necessary because the paired amplified signal pulses and idler pulses must arrive at the sum-frequency generator at the same time as the corresponding SFG pump pulses. The retiming stage 130, which can but need not contain two or more dichroic mirrors 132 and 134 (two are shown for simplicity), is tuned so that the paired amplified signal pulses and idler pulses and the SFG pump pulses can catch up with each other and enter the sum-frequency generator SFG at the same time.

As stated above, the pump source PS time-multiplexes the production of pump pulses. This is necessary because the pump pulses are used in different locations at different times. Initial groups of pump pulses are used in the COPA 120 to produce pairs of amplified signal pulses and idler pulses, and subsequent groups of pump pulses are used in the sum-frequency generator SFG to produce driver pulses. Additionally, the production of pump pulses by the pump source PS must be synchronized with the production of signal pulses by the signal source SS so that the interactions between them can take place as intended. The multiplexing and synchronization means 136 (which will include a computer system) is operatively connected to both the pump source PS and the signal source SS in order to perform these functions. (For clarity, the stages C₁, C₂ . . . C_{N1} of the COPA 120 are shown phase-matched for only a single pair of an amplified signal pulse and an idler pulse. It may be possible to configure these stages C₁, C₂ . . . C_{N1} to work for more than one such pair.)

The driver pulses exiting the sum-frequency generator SFG are directed to an optical output port 138. Upon exiting the optical output port, the driver pulses enter a beam transport and demultiplexing system 140.

The beam transport and demultiplexing system 140 is necessary because the driver pulses exiting the sum-frequency generator SFG are spaced apart in time. It will be recalled that to most efficiently transfer energy to the target pellet, groups of driver pulses must be combined into a single polychromatic pulse. To accomplish this, pairs of beamline filters are used to create beamlines of varying length. The beamline filters are calibrated to cause earlier-produced driver pulses to travel longer beamlines than later-produced driver pulses. Thus, for example, let it be assumed that driver pulses of one color are produced at time t₁, driver pulses of another color are produced at a later time t₂, and driver pulses of a third color are produced still later at time t_{N}. Pairs of dichroic mirrors D₁, D₂, . . . D_{N} direct these pulses driver pulses along beamlines BL₁, BL₂, . . . BL_{N}. Driver pulses produced at time t₁ are caused to travel along the longest beamline BL₁, so they take the longest time to reach the output of the system 140. Driver pulses produced at time t₂ are caused to travel along a shorter beamline BL₂, so they take less time to reach the output of the system 140. And driver pulses produced at time t_{N} travel a still shorter beamline BL_{N} so they take still less time to reach the output of the system 140. By appropriately calibrating the lengths of the beamline BL₁, BL₂, . . . BL_{N}, all the driver pulses can arrive at the output of the system 140 substantially simultaneously.

In this first preferred embodiment, the system 140 is placed after the output port 138. This is a matter of design choice and is not required.

The second harmonic generator 110, collinear optical parametric generator 120, and the sum-frequency generator SFG, do not operate with 100% efficiency. The residual pump power can be recovered using photovoltaic devices and recycled to produce inertial fusion energy (i.e. improve the electrical-to-optical “wall-plug” efficiency of the laser driver), or the optical power can preheat working fluids in the fusion plant as a form of cogeneration (i.e. improve overall efficiency of the fusion plant). Importantly, this scheme requires no additional power for managing thermal loads required for other laser driver schemes.

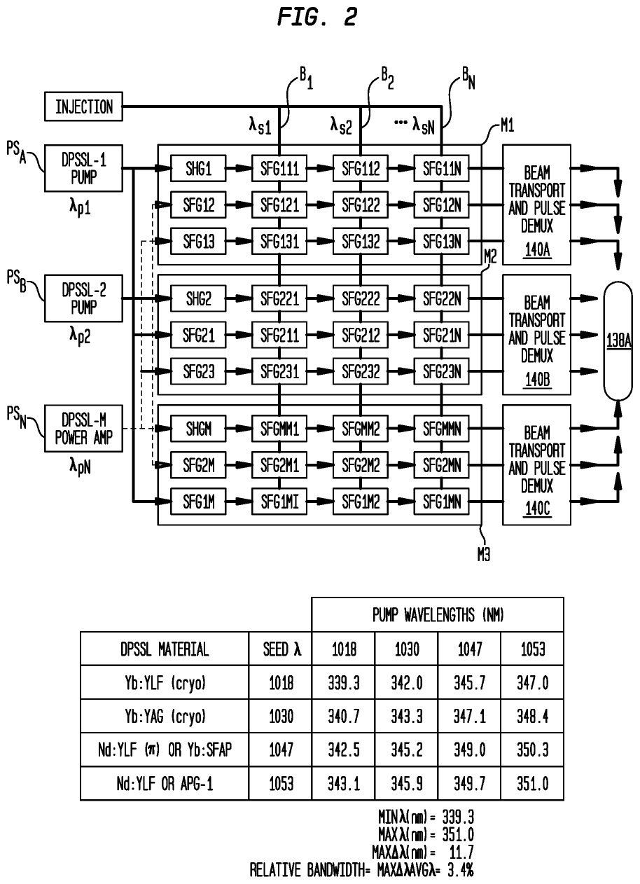

### Second Preferred Embodiment—FIG. 2

The second preferred embodiment shown in FIG. 2 is different from, but has substantial similarities to, the first preferred embodiment shown in FIG. 1. The second preferred embodiment has a signal source Injection that is similar to the signal source SS and generates a polychromatic signal beam containing polychromatic signal pulses. This beam is directed to an optical filter (not shown) that operates the same way that the optical filter OF operates, i.e. that creates a plurality of secondary monochromatic beams B₁, B₂, . . . B_{N} of signal pulses, each having a single wavelength that differs from the wavelengths of the signal pulses in all the other secondary beams.

However, whereas the first preferred embodiment uses a single pump source PS, the second preferred embodiment uses a plurality (here, three are shown but this is not limiting, any number can be used) pump sources PS_{A}, PS_{B}, . . . PS_{N} that are in parallel. The pump pulses produced by each of the pump sources PS_{A}, PS_{B}, . . . PS_{N} are both monochromatic and unique, i.e. the pump pulses produced by the pump source PS A have a wavelength that is different from the wavelengths of the pump pulses produced by the pump sources PS_{B} and PS_{C}.

The pump sources PS_{A}, PS_{B}, . . . PS_{M} may optionally differ from the pump source PS in two other respects. Here, each of the pump sources PS_{A}, PS_{B}, . . . PS_{M} is a diode pumped solid state laser. (Suitable materials for these pump sources are shown in FIG. 2; other materials may be suitable.) And, in the first preferred embodiment, the pump source PS includes a second harmonic generator 40. In this second preferred embodiment, each pump source PS_{A}, PS_{B}, . . . PS_{N} is connected to three second-harmonic/sum-frequency generator matrices, of which one has an initial second harmonic generator and the other two do not. For example, each pump source is connected to matrix M1, M2, and MM. Second harmonic or sum frequency generation produced medium wavelength pump beams that pump series-connected sum-frequency generators. For instances, matrix M1 has an initial second harmonic generator SHG1 followed by series-connected sum-frequency generators SFG111, SFG112 and SFG11N. M1 also has two sum frequency generators SFG12 and SFG13 that create two different pump wavelengths by mixing the output of pump lasers DPSSL-1 (connection not shown in FIG. 2 for clarity) with DPSSL-2 and DPSSL-M, respectively.

Each of the secondary beams is fed into nine sum-frequency generators. For example, the secondary beam B1 is fed into sum-frequency generators SFG111, SFG121, SFG131, SFG221, SFG211, SFG231, SFGMM1, SFG2M1, and SFG1M1. It will be apparent that the matrix configuration of the second preferred embodiment produces NxM driver pulses that scales favorably and can be more polychromatic than those produced by the first preferred embodiment. As illustrated, with three different injection wavelengths and three different high-energy pump lasers, this embodiment produces nine different wavelengths in nine output beams each composed of three time-multiplexed pulses.

As shown, the second preferred embodiment has three beam transport and demultiplexing systems 140A, 140B, and 140C, these operate analogously to the system 140. Together, these systems 140A, 140B, and 140C feed an optical output port 138A.

Although preferred embodiments of the invention have been described above, this description is not limiting and is only exemplary. The scope of the invention is defined only by the following claims:

1. A method of producing polychromatic driver pulses for use in producing fusion energy, comprising the steps of:
a) combining at least one beam of infrared pump pulses with a plurality of monochromatic beams each containing signal pulses of a unique wavelength in a nonlinear process to produce an ensemble of pulse-containing beams; and
b) using second harmonic generation, sum-frequency generation, or both to reduce the wavelength of all of the pulses in all of the beams in the ensemble to ultraviolet wavelengths.

2. The method of claim 1, wherein the combining step is carried out in a collinear optical parametric amplifier.

3. The method of claim 1, wherein the combining step is carried out in a second harmonic generator or a sum-frequency generator.

4. The method of claim 1, wherein the combining step is carried out in a matrix of sum-frequency generators made up of sum-frequency generators connected in series.

5. A laser driver module for producing fusion energy, comprising:
a) a signal source, the signal source producing a polychromatic primary beam of N time-multiplexed, polychromatic signal pulses;
b) an optical filter segregating the polychromatic signal pulses in the primary beam into a plurality N₁ of monochromatic secondary beams of signal pulses, each secondary beam containing monochromatic signal pulses having a single wavelength that differs from the wavelengths of the signal pulses in all the other secondary beams;
c) a pump source, the pump source producing a monochromatic beam of pump pulses;
d) a multistage collinear optical parametric amplifier, the optical parametric amplifier having N1 stages, each stage containing a nonlinear optical element that receives the beam of pump pulses and a unique one of the N₁ monochromatic secondary beams of signal pulses;
e) multiplexing and synchronizing means operatively connected to the signal source and the pump source, the multiplexing and synchronizing means causing the signal source to produce a primary beam of time-multiplexed signal pulses, causing the pump source to produce a beam of 2N₁ time multiplexed pump pulses of which N₁ pulses will be used in the optical parametric amplifier and of which N₁ pulses will be used in a sum-frequency generator located downstream of the optical parametric amplifier, and causing the production of signal pulses and the production of pump pulses to be synchronized so as to cause each of the optical parametric amplifier stages to receive corresponding signal pulses and pump pulses simultaneously and to thereby produce amplified signal pulses paired with idler pulses;
f) an N₂-stage sum frequency generator located downstream of the optical parametric amplifier, each of the N₂ stages containing a nonlinear optical element that receives unique pairs of amplified signal and idler pulses together with pump pulses, to produce 2N₂ unique driver pulses of short wavelength;
g) a time-delay stage interposed between the optical parametric amplifier and the sum frequency generator and delaying the pump pulses to temporally synchronize them temporally with N₂ pairs of amplified signal and idler pulses for sum-frequency generation; and
h) synchronization and combination means receiving the 2N₂ unique short-wavelength pulses and synchronizing and combining them in such a manner as to cause all of them to arrive at an optical output simultaneously.

6. The driver module of claim 5, wherein the signal pulses in the primary beam have infrared wavelengths, the beam of pump pulses has medium wavelengths, and the laser driver pulses have ultraviolet wavelengths.

7. The driver module of claim 5, wherein the primary beam is output from a non-linear optical parametric amplifier in the signal source.

8. The driver module of claim 5, wherein the N₁ stages of the collinear optical parametric amplifier are connected in series.

9. The driver module of claim 5, wherein the N₂ stages of the sum-frequency generator are connected in series and each stage outputs a unique pair of laser driver pulses, each pair including a signal pulse and an idler pulse.

10. The driver module of claim 5, wherein there is an optical path between each of the N₂ nonlinear optical elements in the sum-frequency generator and the optical output means, and wherein synchronization of the laser driver pulses is accomplished by selectively varying the length of each optical path.

11. The driver module of claim 5, wherein each optical path includes a beamline filter and a beamline extending from the beamline filter to the optical output means.

12. The driver module of claim 5, wherein the beamline filter is a grating or a dichroic mirror or a polarizer.

13. The driver module of claim 5, wherein the pump pulses are produced by a single laser system operating at wavelengths of 1053 nm or 1047 nm.

14. The driver module of claim 5, wherein the nonlinear optical elements are of lithium triborate, potassium dihydrogen phosphate, or deuterated potassium dihydrogen phosphate.

15. The driver module of claim 5, wherein the optical synchronizing means comprises N₂ dichroic mirrors or wavelength selective devices.

16. The driver module of claim 5, wherein each optical path includes a dichroic mirror.

17. The driver module of claim 5, wherein the pump source comprises exactly one pump laser.

18. The driver module of claim 5, wherein N₁ equals N₂.

19. The driver module of claim 5, wherein N₁ and N₂ are not equal and can be less than N.

20. A laser driver for producing fusion energy, comprising:
a) a signal source, the signal source producing a polychromatic primary beam of polychromatic signal pulses;
b) an optical filter segregating the polychromatic signal pulses in the primary beam into a plurality N of monochromatic secondary beams of signal pulses, each secondary beam containing monochromatic signal pulses having a single wavelength that differs from the wavelengths of the signal pulses in all the other secondary beams;
c) a plurality of M pump sources, each pump source producing a beam of pump pulses;
d) a plurality of sum-frequency generator matrices each made up of a plurality of sum-frequency generators connected in series, with each sum-frequency generator receiving a beam of pump pulses from one of the pump sources and a monochromatic secondary beam of signal pulses; and
e) means for temporally synchronizing ultraviolet driver pulses from the sum-frequency generator matrices.

21. A method of producing short wavelength driver pulses for use in producing fusion energy, comprising:
a) using a signal source producing a polychromatic primary beam of signal pulses;
b) using one and only one pump laser to produce a temporally multiplexed beam of pump pulses;
c) causing monochromatic signal pulses from the polychromatic primary beam to interact nonlinearly with specific pump pulses, each such interaction producing an amplified signal pulse that is paired with an idler pulse;
d) causing the paired amplified signal pulses idler pulses to produce short-wavelength driver pulses by nonlinear interaction with pump pulses; and
e) causing the driver pulses to arrive at a target location simultaneously.

22. The method of claim 21, wherein said nonlinear interaction of monochromatic signal pulses with pump pulses occurs in an optical parametric amplifier.

23. The method of claim 21, wherein said nonlinear interaction of amplified signal pulses, idler pulses, and pump pulses occurs in a sum-frequency generator.

24. A method of producing short-wavelength drive pulses for use in producing fusion energy, comprising:
a) using one and only one pump laser to produce first and second groups of pump pulses
b) using pump pulses in the first group in a collinear optical parametric amplifier;
c) using pump pulses in the second group in a sum-frequency generator located downstream of the collinear optical parametric amplifier; and
d) synchronizing drive pulses output from the sum-frequency generator to arrive at a target location simultaneously.
